(19) United States
(12) Patent Application Publication
(10) Pub. No.: US 2010/0255160 A1
(43) Pub. Date: Oct. 7, 2010

(54) METHOD OF HOT DOG PREPARATION

(76) Inventor: SHANE Gihsen CAGLE, (US)

Correspondence Address: LAW OFFICE OF JERRY D. HAYNES , P.A, P.O. Box 350392, Fort Lauderdale, FL, 33335, US

(21) Appl. No.: 12/419,995

(22) Filed: Apr. 7, 2009

(51) Int. Cl. A23L 1/317; A23L 1/01

(52) U.S. Cl. 426/243; 426/518

(57) ABSTRACT

The present invention relates to a method of food preparation including the steps of: cooking a hot dog; removing excess moisture from the hot dog; splitting the hot dog lengthwise; adorning the split hot dog with mashed potatoes; applying cheese over the mashed potatoes; and broiling the combination of hot dog, mashed potatoes and cheese until the cheese is substantially melted. This unique combination provides a complete hot dog based meal.

### BACKGROUND OF INVENTION

1. Field of Invention

The present invention relates to a method of food preparation specifically hotdog preparation.

2. Description of Related Art

Hotdogs are a popular meat product enjoyed by many individuals. The hotdog is a cured or a smoked form of sausage made from a variety of meats such as pork, beef, chicken or turkey. Although most hotdogs are precooked before purchase, many consumers cook hotdogs prior to eating by boiling, broiling, grilling or even frying.

A hotdog is commonly served on a bun and adorned with condiments as preferred by the consumer. Hotdogs generally lack spicing that is associated with other sausages such as bratwursts or polish sausage. The traditional condiments used on hotdogs include mustard, ketchup, pickles, onions, pickle relish, sauerkraut, lettuce, tomato, cheese, chili peppers. Hotdogs have also been served with chili and/or cheese to add flavor and variety to the taste thereof. Hotdogs are occasionally sold on a stick after being dipped in cornbread batter and deep-fried in oil thus creating the corndog. Other particular styles of hotdogs have developed over time such as the Chicago-style, New York-style, red hot or footlong to name a few.

Hotdogs have therefore become a stable base of an enjoyable and tasty meal that many people enjoy. Hotdogs are served in many restaurants and some restaurants have specifically dedicated their menu to hotdogs.

### SUMMARY OF THE INVENTION

The present invention relates to a method of food preparation comprising: cooking a hot dog; removing excess moisture from the hot dog; splitting the hot dog lengthwise; adorning the split hot dog with mashed potatoes; applying cheese over the mashed potatoes; and broiling the combination of hot dog, mashed potatoes and cheese until the cheese is substantially melted. The hot dog may be cooked by either boiling or cooking in a microwave oven. The cheese may be applied by grating a desired flavor of cheese.

### BRIEF DESCRIPTION OF DRAWINGS

FIG. 1 depicts a view of a hotdog product according to the present invention.

### DETAILED DESCRIPTION

The present invention relates to a method of hotdog preparation that provides a delicious enjoyable meal for individuals or groups of people. The present invention provides a delicious combination of hotdogs, mashed potatoes and cheese which when prepared in the manner described below provides a satisfying meal.

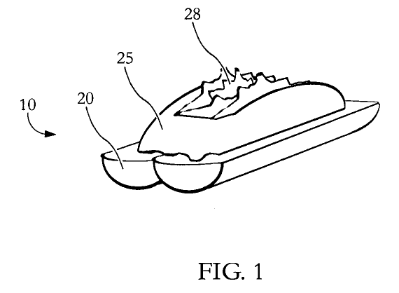

As depicted in FIG. 1, the present invention includes a base of hotdogs adorned by mashed potatoes and accompanied with cheese. The method of preparation according to the present invention includes a first step of boiling hotdogs to a desired temperature or degree of doneness. The boiling time for the hot dogs may vary, however in one exemplary embodiment the hot dogs may be boiled five to six minutes. As an alternative to boiling, the hotdogs may be prepared in a microwave oven at a medium high set temperature. The type of hot dog used with this method of hotdog preparation may vary. Hot dogs have been known to be made of beef, pork, turkey, chicken and even soy or tofu for vegetarian style of hot dog.

After the hotdogs are cooked in a desired manner, the excess moisture may be removed from the hotdogs and then the hotdog is split lengthwise down the middle. As depicted in FIG. 1, a hotdog 20 is shown which is split as contemplated by the present invention. Prior to cooking the hotdogs, mashed potatoes are prepared in a manner as desired. The preparation time for the mashed potatoes may also vary depending on type and style of preparation, however in one exemplary embodiment the potatoes may be prepared in five to ten minutes. The mashed potatoes are adorned over the split hotdog as the next step in preparing the hot dog according to the present invention. The mashed potatoes cover a substantial portion of the hotdog. The next step according to the present invention, involves grating cheese over the mashed potatoes as desired. As depicted in FIG. 1, a hotdog based meal 10 includes a hotdog 20 adorned with mashed potatoes 25 and topped off with the grated cheese 28. Any type of cheese is suitable for the present invention and may include cheddar, Swiss, Colby or Monterrey jack.

The final step in preparation of the hotdogs according to the present invention, involves broiling this combination of hotdog, mashed potatoes and cheese until the cheese is melted and completely caramelized over the mashed potatoes. This meal may be served on a plate or the hotdog, potato and cheese combination be placed over a slice of bread or any bun and served in a traditional manner. This combination of ingredients provides a flavorful and filling meal and also has a potential to be packaged after preparation so that it may be stored and reheated for later consumption.

What is claimed is:

1. A method of food preparation comprising the steps of:
a. cooking a hot dog;
b. removing excess moisture from the hot dog;
c. splitting the hot dog lengthwise;
d. adorning the split hot dog with mashed potatoes;
e. applying cheese over the mashed potatoes; and
f. broiling the combination of hot dog, mashed potatoes and cheese until the cheese is substantially melted.

2. The method of food preparation according to claim 1, where the step of cooking includes at least one of boiling and microwave oven cooking.

3. The method of food preparation according to claim 2, where the step of cooking may take no longer than six minutes.

4. The method of food preparation according to the claim 1, where the total preparation time is no greater than seventeen minutes.

5. The method of food preparation according to claim 1, where step of applying cheese includes grating cheese.
